(19) United States
(12) Patent Application Publication
(10) Pub. No.: US 2018/0207536 A1
(43) Pub. Date: Jul. 26, 2018

(54) SYSTEM AND METHOD FOR MANAGING GLOBAL POSITION INFORMATION IN ONLINE GAMES

(71) Applicant: Machine Zone, Inc., Palo Alto, CA (US)

(72) Inventor: Quan Gu, Emerald Hills, CA (US)

(21) Appl. No.: 15/817,522

(22) Filed: Nov. 20, 2017

Related U.S. Application Data
(60) Provisional application No. 62/450,752, filed on Jan. 26, 2017.

(51) Int. Cl. A63F 13/79; H04W 4/02; A63F 13/45; A63F 13/53; A63F 13/65; A63F 13/92; A63F 13/332

(52) U.S. Cl. CPC A63F 13/79; H04W 4/025; A63F 13/45; A63F 13/332; A63F 13/65; A63F 13/92; A63F 13/53

(57) ABSTRACT

Implementations of the present disclosure are directed to a method, a system, and an article for managing the use of global position information in a multi-player online game. An example method can include: providing an online game on a mobile device configured to determine global position information for the mobile device; determining that an approximate location for the mobile device corresponds to a target geographical region; sending a request to a user of the mobile device to share the global position information for the mobile device; detecting that the user is sharing the global position information for the mobile device; confirming, based on the shared global position information, that the mobile device is within the target geographical region; and providing an enhanced version of the online game on the mobile device.

### CROSS-REFERENCE TO RELATED APPLICATIONS

This application claims the benefit of U.S. Provisional Patent Application No. 62/450,752, filed Jan. 26, 2017, the entire contents of which are incorporated by reference herein.

### BACKGROUND

The present disclosure relates to multi-player online games and, in some examples, to systems and methods for managing the sharing and use of global position information for mobile devices in multi-player online games.

In general, a multi-player online game can be played by hundreds of thousands or even millions of players who use client devices to interact with a virtual environment for the online game. The players are typically working to accomplish tasks, acquire assets, or achieve a certain score or level in the online game. Some games require or encourage players to form groups or teams that can play against other players or groups of players.

In a typical example, a player interacts with the virtual environment by providing input to a user input device. Common user input devices for games can include, for example, a touch screen, a keypad, a joystick, and/or a keyboard. With a touch screen, users can interact with the virtual environment by tapping or selecting items displayed on the screen.

Many mobile client devices include components that allow global positions of the mobile devices to be determined, for example, through the use of a global positioning system or radio tower multilateration. Users typically can choose between sharing or not sharing such global position information from the mobile devices. When users choose to share the global position information, operators of games or other applications can use the global position information to gain valuable insights into where and how the applications are used and/or can provide certain application features that require the global position information. Due to privacy, power usage, and other concerns, however, many users choose to not share the global position information.

### SUMMARY

In general, the systems and methods described herein relate to online games and other applications that access and use global position information for mobile client devices. When a user elects to share the global position information, an enhanced version of an online game can be provided to the user. If the user decides to stop sharing the global position information, the user can lose any progress that was made when the global position information was shared. In this way, the user is incentivized by the online game to continue sharing the global position information.

Advantageously, the approach of using an online game to incentivize the sharing of global position information can result in improved access to global position information for developers and operators of online games and other applications. The information can allow the developers and operators to determine how and where the online games and applications are used. For example, the developers and operators can determine where users were located when the users took certain actions in the game or related to the game. This information can greatly improve the ability of the developers and operators to customize or enhance the game and/or any marketing for the game.

In some instances, for example, use of global position information can improve user engagement with an online game by connecting users with other users who are located in a similar physical region (e.g., neighborhood, city, or state). Such users can be introduced to one another and/or encouraged to interact with one another in a common virtual environment. Alternatively or additionally, such users can be encouraged to form teams that compete in the online game with other teams from different physical regions. Such affiliations with other users from the same or similar community can result in more user enjoyment and/or satisfaction with the online game.

Additionally or alternatively, in certain examples, the online game can guide or encourage such users to connect with one another in a real world environment (e.g., outside of the virtual environment). The users can be encouraged to perform tasks together (e.g., a scavenger hunt in a theme park) to gain virtual items or other rewards for use in the virtual environment. The approach can integrate online and offline experience and create social connections among users, thereby improving user interest in and engagement with the online game.

Advantageously, use of the global position information can further enhance online games and other applications that involve augmented reality. A conventional augmented reality application can detect and display real world objects (e.g., trees or buildings) and add virtual elements to the display, With the approach described herein, however, the display can be further augmented according to a known global position of the user. For example, virtual representations of people, animals, or objects corresponding to the known global position (e.g., a city or theme park) can be added to the display.

In one aspect, the subject matter described in this specification relates to a computer-implemented method. The method includes: providing an online game on a mobile device configured to determine global position information for the mobile device; determining that an approximate location for the mobile device corresponds to a target geographical region; sending a request to a user of the mobile device to share the global position information for the mobile device, wherein the request includes an invitation to experience an enhanced version of the online game corresponding to the target geographical region; detecting that the user is sharing the global position information for the mobile device; confirming, based on the shared global position information, that the mobile device is within the target geographical region; and providing the enhanced version of the online game on the mobile device.

In certain examples, the mobile device can be configured to determine the global position information using at least one of a global positioning system and a radio signal multilateration system. The target geographical region can correspond to a room, a building, a street, a neighborhood, a park, a town, a city, a business, or any combination thereof. Determining the approximate location can include using at least one of a Wi-Fi network and a wireless personal area network. The enhanced version of the online game can include elements tailored for the target geographical region. The enhanced version of the online game can be or include a support game.

In some implementations, the method can include: determining, based on the shared global position information, that the mobile device has left the target geographical region; and reverting back to an original version of the online game on the mobile device. The method can include providing an incentive to the user of the mobile device to continue sharing the global position information for the mobile device. Providing the incentive can include providing a notification to the user of the mobile device, wherein the notification is configured to inform the user of an advantage that will be available in the online game if the user continues to share the global position of the mobile device. The advantage can be or include an improved ability to advance in the online game, an ability to retain an advancement achieved in the enhanced version, and/or an ability to retain an asset earned in the enhanced version.

In another aspect, the subject matter described in this specification relates to a system. The system includes one or more computer processors programmed to perform operations that include: providing an online game on a mobile device configured to determine global position information for the mobile device; determining that an approximate location for the mobile device corresponds to a target geographical region; sending a request to a user of the mobile device to share the global position information for the mobile device, wherein the request includes an invitation to experience an enhanced version of the online game corresponding to the target geographical region; detecting that the user is sharing the global position information for the mobile device; confirming, based on the shared global position information, that the mobile device is within the target geographical region; and providing the enhanced version of the online game on the mobile device.

In certain examples, the mobile device can be configured to determine the global position information using at least one of a global positioning system and a radio signal multilateration system. The target geographical region can correspond to a room, a building, a street, a neighborhood, a park, a town, a city, a business, or any combination thereof. Determining the approximate location can include using at least one of a Wi-Fi network and a wireless personal area network. The enhanced version of the online game can include elements tailored for the target geographical region. The enhanced version of the online game can be or include a support game.

In some implementations, the method can include: determining, based on the shared global position information, that the mobile device has left the target geographical region; and reverting back to an original version of the online game on the mobile device. The method can include providing an incentive to the user of the mobile device to continue sharing the global position information for the mobile device. Providing the incentive can include providing a notification to the user of the mobile device, wherein the notification is configured to inform the user of an advantage that will be available in the online game if the user continues to share the global position of the mobile device. The advantage can be or include an improved ability to advance in the online game, an ability to retain an advancement achieved in the enhanced version, and/or an ability to retain an asset earned in the enhanced version.

In another aspect, the subject matter described in this specification relates to an article. The article includes a non-transitory computer-readable medium having instructions stored thereon that, when executed by one or more computer processors, cause the computer processors to perform operations including: providing an online game on a mobile device configured to determine global position information for the mobile device; determining that an approximate location for the mobile device corresponds to a target geographical region; sending a request to a user of the mobile device to share the global position information for the mobile device, wherein the request includes an invitation to experience an enhanced version of the online game corresponding to the target geographical region; detecting that the user is sharing the global position information for the mobile device; confirming, based on the shared global position information, that the mobile device is within the target geographical region; and providing the enhanced version of the online game on the mobile device.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for managing the use of global position information in a multi-player online game.

FIG. 2 is a schematic diagram of an example system in which a mobile client device is located within a target geographical region and is in communication with cell phone towers and a local network.

FIG. 3 is a flowchart of an example method of managing the use of global position information in a multi-player online game.

### DETAILED DESCRIPTION

In various implementations, the subject matter of this disclosure relates to the use of global position information for mobile devices in online games or other applications. The global position information can be or include, for example, latitude and longitude coordinates and/or a description of a geographical location, such as a street address, a neighborhood, a park, a region, a city, a state, and/or a country. The global position information for a mobile device can be obtained using, for example, a global positioning system (GPS) and/or radio tower multilateration (e.g., cell phone tower triangulation). Other suitable techniques for determining the global position of the mobile device are possible.

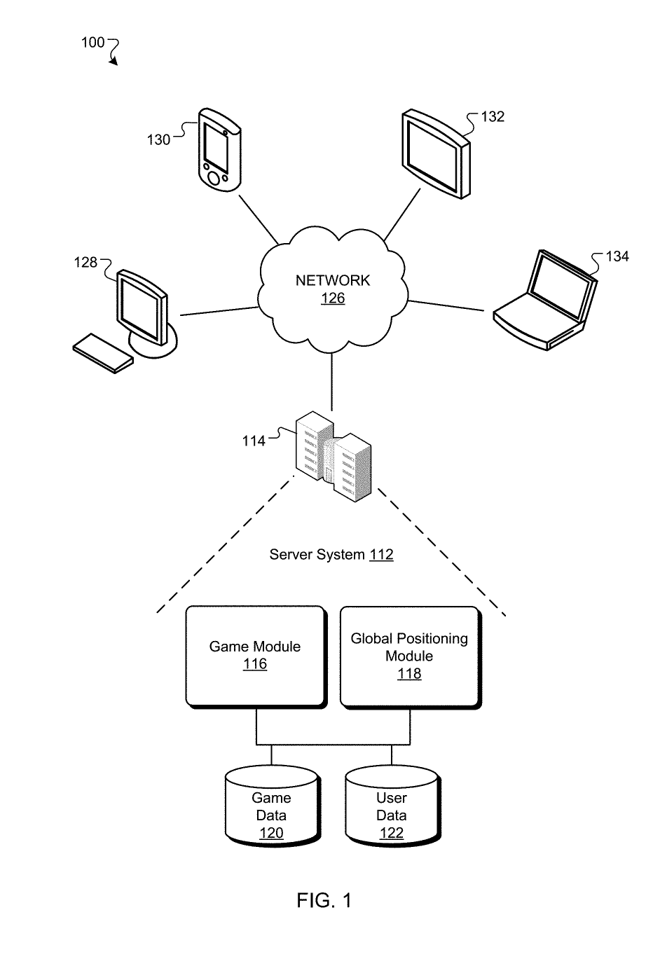

FIG. 1 illustrates an example system 100 for encouraging users to share global position information in a multi-player online game. A server system 112 provides functionality for providing an online game that utilizes global position information obtained from mobile client devices. The server system 112 includes software components and databases that can be deployed at one or more data centers 114 in one or more geographic locations, for example. The server system 112 software components can include a game module 116 and a global positioning module 118. The software components can include subcomponents that can execute on the same or on different individual data processing apparatus. The server system 112 databases can include game data 120 and user data 122 databases. The databases can reside in one or more physical storage systems. The software components and data will be further described below.

An application, such as, for example, a web-based application, can be provided as an end-user application to allow users to interact with the server system 112. The end-user application can be accessed through a network 126 (e.g., the Internet) by users of client devices, such as a personal computer 128, a smart phone 130, a tablet computer 132, and a laptop computer 124. Other client devices are possible. In alternative examples, the game data 120 and/or the user data 122 or any portions thereof can be stored on one or more client devices. Additionally or alternatively, software components for the system 100 (e.g., the game module 116 and/or the global positioning module 118) or any portions thereof can reside on or be used to perform operations on one or more client devices.

FIG. 1 depicts the game module 116 and the global positioning module 118 as being able to communicate with the databases (e.g., the game data 120 and the user data 122 databases). The game data 120 database generally includes information related to the multi-player online game implemented using the system 100. The game data 120 database can include, for example, information related to a virtual environment for the game, image, video and/or audio data for the game, event data corresponding to previous, current or future game events, and/or game state data defining a current state of the game. The user data 122 database generally includes data related to user interactions with the online game and/or the virtual environment. Such information can be or include, for example, a history of user connections to the system 100, user purchases, user accomplishments, user tasks, user interactions with other users (e.g., group chats), user virtual item acquisition or usage, and/or other user conditions in the virtual environment and/or real world. The user data 122 database can include information related to the global positions of mobile client devices, such as, for example, a history of times and/or locations where users interacted with the online game.

In various examples, the users or players of the online game can have certain user capabilities in the virtual environment. The user capabilities can be or include, for example, moving an avatar or a virtual item or object to a different geographical location, interacting with characters or other users, participating in user groups or alliances, attacking other users, deploying troops, defending against an attack from other users, deploying defenses, building or modifying a virtual item or object (e.g., a virtual building or other structure), developing a new skill, operating a vehicle, acquiring a virtual item (e.g., a weapon), using or interacting with a virtual item (e.g., a playing card or a weapon), and performing supernatural tasks (e.g., casting a spell). Other user capabilities are possible.

The virtual environment for the online game can be rendered for users in the form of, for example, graphics, images, video, audio, text, and/or haptic feedback. In an adventure game, for example, a graphical user interface can display a virtual environment that includes representations of characters (e.g., people or animals), natural features (e.g., mountains, rivers, fields, trees, and/or weather conditions), and/or man-made features (e.g., buildings, bridges, and/or vehicles).

In some examples, when a user's physical location is known (e.g., based on global position information from the user's mobile device), the rendering of the online game can be adapted or enhanced according to the physical location. For example, the online game can provide the user with an enhanced virtual environment that includes representations of one or more features and/or conditions (e.g., weather or the like) at or in close proximity to the user's physical location. To determine environmental conditions, for example, the online game can obtain local weather information and/or daylight conditions from one or more weather databases or weather forecast services (e.g., OPENWEATHERMAP or ACCUWEATHER). The enhanced virtual environment can then be provided with representations of cloud conditions, precipitation (e.g., rain or snow), wind, sun position, moon phase, and/or moon position, and the like, corresponding to current conditions in the user's physical location. In some instances, users who are physically located near one another (e.g., in the same building, neighborhood, park, or city) can experience the same enhanced virtual environment and/or can interact with one another within the enhanced virtual environment. Other users who are far away or in remote physical locations may be unable to access the enhanced virtual environment.

In some examples, an enhanced virtual environment can allow users to experience certain game features and/or have certain capabilities that may not be available outside of the enhanced virtual environment (e.g., in an unenhanced or original virtual environment for the game). For example, the enhanced virtual environment can allow users to view or experience special themes (e.g., colors, decorations, characters, clothing, structures, music, etc.) and/or acquire unique assets (e.g., virtual clothing, gifts, weapons, etc.). Alternatively or additionally, the enhanced virtual environment can allow users to play one or more variations of the online game, for example, according to different rules. The game variations can be more favorable to users in certain respects, when compared to game play in the original virtual environment. For example, the game variations can allow the users to make advancements that may be more difficult to achieve in the original virtual environment. Additionally or alternatively, users can preferably obtain virtual items, points, level increases, or other assets or advancements that may not be available outside of the enhanced virtual environment. Additionally or alternatively, users can be presented with a separate online game, such as a mini-game or support game, which can be tailored to a particular geographical location and played while the mobile device is within or in close proximity to the target geographical location.

In certain implementations, the online game is able to provide the enhanced virtual environment to users who share the global position information from their mobile devices. To encourage users to share the global position information, the online game can take various actions. In some instances, for example, the online game can display a prompt or other message on a client device that informs the user about certain game features that can be accessed if the user shares global position information with the online game. If the user elects to share the global position information, the user can then take advantage of enhanced virtual environments or other game features that utilize global position information. The prompt can be provided to the user at certain time intervals (e.g., daily, weekly, or monthly) and/or be based on a status of the online game (e.g., when the user reaches a certain level or score or acquires a certain virtual item). Alternatively or additionally, the prompt can be provided based on an approximation of the user's global position, as described herein.

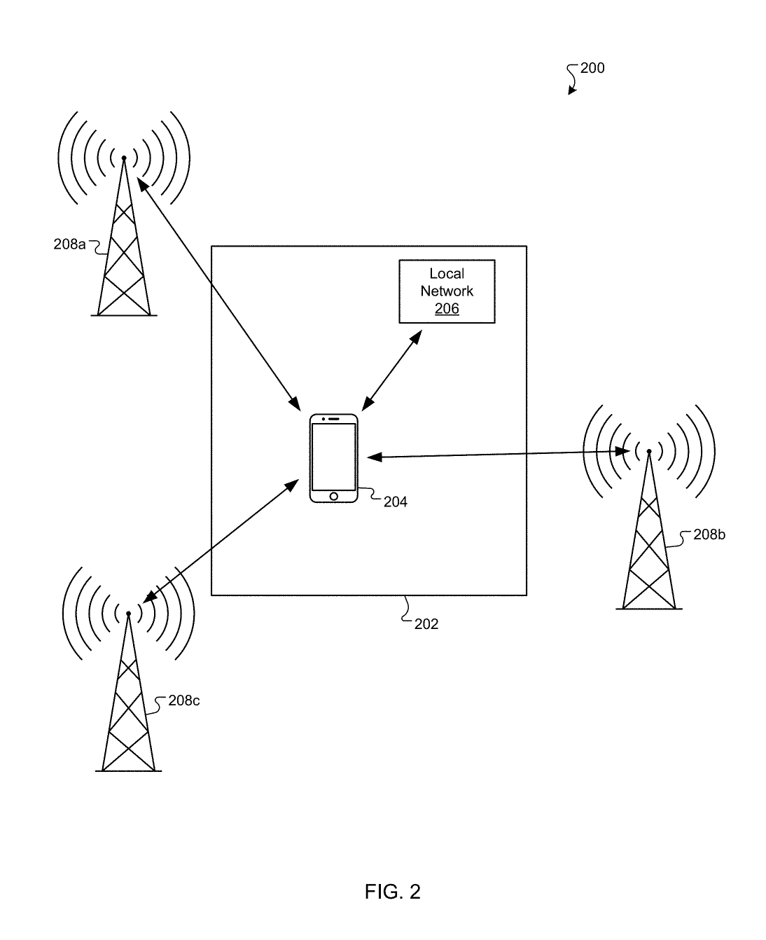

Referring to FIG. 2, for example, a system 200 can include a target geographical region 202, a mobile device 204, a local network 206, and a plurality of cell phone towers 208a, 208b, and 208c. In general, the target geographical region 202 is associated with an enhanced virtual environment for the online game and can be or include, for example, a room, a building, a street, a neighborhood, a park, a town, a city, a business, or other physical area. In various examples, when the mobile device 204 is already sharing global position information (e.g., obtained using the cell phone towers 208a, 208b, and 208c or through GPS functionality available on the mobile device 204) with the online game, the online game can confirm that the mobile device 204 is located within the target geographical region 202. The mobile device 204 can then be given access to the enhanced virtual environment associated with the target geographical region 202.

Alternatively, when the user is not currently sharing global position information for the mobile device 204, the online game (e.g., using the global positioning module 118) can encourage the user to share the global position information, for example, by informing the user about the availability of the enhanced virtual environment. To inform the user, a prompt can be sent to the mobile device 204 using the local network 206, which can use or include, for example, a Wi-Fi network and/or a wireless personal area network (e.g., using BLUETOOTH or low energy BLUETOOTH). The local network 206 can determine an approximate location for the mobile device 204 (e.g., based on an IP address for the local network 206) and can send the prompt when the approximate location is determined to be within or close to the target geographical region 202. In one example, the local network 206 can detect devices within about 100 feet (about 30 meters) of an antenna or other access point for the local network 206. The detection distance for a device can be less (e.g., about 10 feet or 3 meters) when one or more obstacles (e.g., walls) are between the device and the antenna. When the user elects to share global position information, the online game can determine a more precise location for the mobile device 204 (e.g., using the cell phone towers 208a, 208b, and 208c or through GPS functionality available on the mobile device 204) and can confirm that the mobile device 204 is within or in close proximity to the target geographical region 202. When the global position is confirmed, the user can be given access to the enhanced virtual environment associated with the target geographical region 202.

In general, the enhanced virtual environment can be any distinct rendering of the virtual environment for the online game that is preferably tailored for the target geographical region 202. In one example, the target geographical region 202 can be a movie theater and the enhanced virtual environment can be tailored for a specific movie or type of movie playing at the movie theater. Alternatively or additionally, the target geographical region 202 can be an amusement park and the enhanced virtual environment can be tailored to include elements or themes from the amusement park. In some examples, the enhanced virtual environment can be the same as or similar to the virtual environment for the online game with the exception of one or more graphical, audio, or other elements representing the target geographical region 202. When a user is in a DISNEY theme park, for example, a castle in the virtual environment for the online game can be changed to look like Cinderella's castle. Alternatively or additionally, the enhanced virtual environment can be or include a separate or distinct virtual environment (e.g., for a support game or other associated game) that has little or no resemblance with or connection to the original virtual environment for the online game. In that case, the enhanced virtual environment can be for a support game that allows the user to earn items or other rewards that can be used in the online game.

In various examples, the online game can use the global position information to monitor a position of the mobile device 204 in and around the target geographical region 202. If the online game determines that the mobile device 204 has left the target geographical region 202, the online game can deactivate the enhanced virtual environment and reinstate the original virtual environment for the online game. At this point, given that the enhanced virtual environment is no longer available, the user may decide to stop sharing the global position information. To incentivize the user to continue sharing the global position information, the online game can provide the user with, for example, the following options: (i) stop sharing global position information and forfeit any gains and/or items obtained in the enhanced virtual environment, or (ii) continue sharing the global position information and be allowed to retain any such gains and/or items for use in the original virtual environment and/or the enhanced virtual environment. Presented with this option, the user may choose to continue sharing the global position information, particularly if the user made significant advancements or acquired assets in the enhanced virtual environment. For example, if the user is on vacation near the target geographical region 202 (e.g., an amusement park or a theme park) for a few days or more, the user may want to have access to the enhanced virtual environment when the user revisits the target geographical region 202 each successive day. In that case, the user can elect to continue sharing the global position information, rather than having to re-activate the sharing each time the user enters the target geographical region 202. In preferred examples, any gains and/or items acquired by the user in the enhanced virtual environment can be stored (e.g., in the user data 122 database). If the user continues sharing the global position information, the gains and/or items can be made available to the user in the enhanced virtual environment when the user re-enters the target geographical area 202 at any time in the future. Alternatively, however, the user may choose to stop sharing the global position information, in which case any advancements or acquired assets from the enhanced environment may be forfeited, hidden, or otherwise unavailable to the user.

To provide a further incentive to continue sharing the global position information, the user can be informed that such sharing will make it permissible, easier, or less expensive for the user to upgrade to a new level or power and/or to use acquired items when the player returns to the original virtual environment. In some examples, certain advancements or assets can be made available only in the enhanced virtual environment. This can make such advancements or assets difficult to obtain and/or can make a loss of the advancements or assets more difficult for the user.

In various instances, a record can be maintained (e.g., in the user data 122 database) of any advancements and/or assets that were obtained by the user in the enhanced virtual environment. The record can be used to reinstate any lost advancements and/or items acquired in the enhanced virtual environment if the user later decides to resume the sharing of global position information. The reinstatement can occur if the user is inside or outside the target geographical region 202.

In certain implementations, the use of global position information can allow users to be grouped in the virtual environment according to physical location. In an adventure game, for example, rather than allocating users to random virtual environments or virtual locations, users can be allocated according to their physical locations. This can allow users who live in or are visiting a specific city, state, or country, for example, to interact with one another in a virtual environment corresponding to the city, state, or country. The users could form groups or alliances that can compete against other groups or alliances, for example, of users from different physical locations. In one example, when a user travels to a different physical location, the user can become a guest player in a virtual environment for the physical location. The guest player can receive special gains or items as a guest that can only be retained if the user continues to share global position information. In this way, the online game can provide a virtual vacation experience when the user is traveling away from home. In preferred implementations, the sharing of global position information can be a prerequisite for such a game experience.

In some examples, to encourage users to share global position information, notifications can be provided that inform users about the availability of enhanced virtual environments. The notifications can be provided online or offline. When an enhanced virtual environment is available for a target geographical region (e.g., an amusement park), for example, notifications can be placed in and around the target geographical region. In some examples, the notifications can encourage users to download the application for the online game. In response to the notification, a user can play the online game and decide to share global position information. The enhanced virtual environment can then be provided to the user.

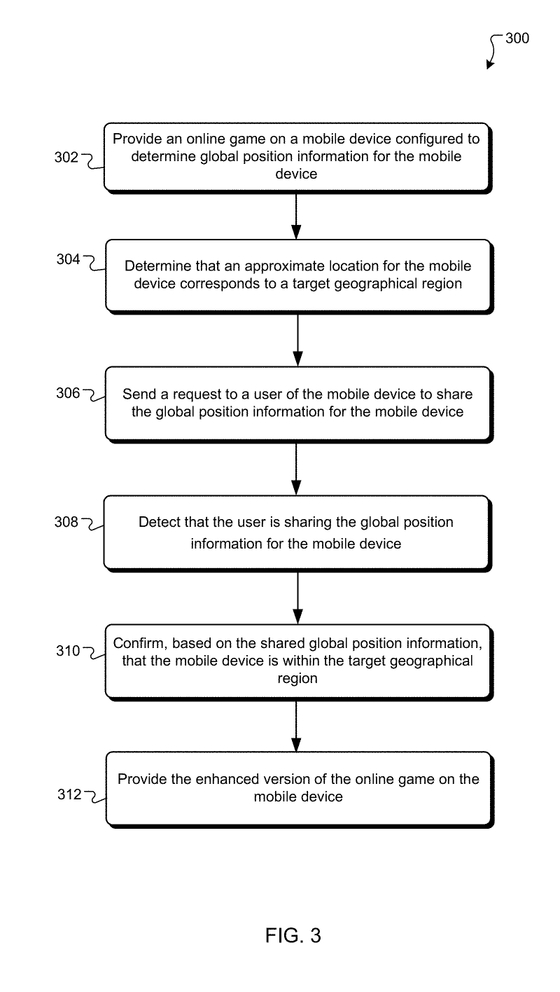

FIG. 3 illustrates an example computer-implemented method 300 of encouraging users to share global position information and using the global position information in an online game. An online game is provided (step 302) on a mobile device configured to determine global position information for the mobile device. An approximate location for the mobile device is determined (step 304) to correspond to a target geographical region. A request is sent (step 306) to a user of the mobile device to share the global position information for the mobile device. The request can include an invitation to experience an enhanced version of the online game corresponding to the target geographical region. The method includes detecting (step 308) that the user is sharing the global position information for the mobile device. Based on the shared global position information, the mobile device is confirmed (step 310) to be within the target geographical region. The enhanced version of the online game is provided (step 312) on the mobile device.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method comprising:
providing an online game on a mobile device configured to determine global position information for the mobile device;
determining that an approximate location for the mobile device corresponds to a target geographical region;
sending a request to a user of the mobile device to share the global position information for the mobile device,
wherein the request comprises an invitation to experience an enhanced version of the online game corresponding to the target geographical region;
detecting that the user is sharing the global position information for the mobile device;
confirming, based on the shared global position information, that the mobile device is within the target geographical region; and
providing the enhanced version of the online game on the mobile device.

2. The method of claim 1, wherein the mobile device is configured to determine the global position information using at least one of a global positioning system and a radio signal multilateration system.

3. The method of claim 1, wherein the target geographical region corresponds to at least one of a room, a building, a street, a neighborhood, a park, a town, a city, a business, and any combination thereof.

4. The method of claim 1, wherein determining the approximate location comprises using at least one of a Wi-Fi network and a wireless personal area network.

5. The method of claim 1, wherein the enhanced version of the online game comprises elements tailored for the target geographical region.

6. The method of claim 5, wherein the enhanced version of the online game further comprises a support game.

7. The method of claim 1, further comprising:
determining, based on the shared global position information, that the mobile device has left the target geographical region; and
reverting back to an original version of the online game on the mobile device.

8. The method of claim 1, further comprising:
providing an incentive to the user of the mobile device to continue sharing the global position information for the mobile device.

9. The method of claim 8, wherein providing the incentive comprises providing a notification to the user of the mobile device, wherein the notification is configured to inform the user of an advantage that will be available in the online game if the user continues to share the global position of the mobile device.

10. The method of claim 9, wherein the advantage comprises at least one of an improved ability to advance in the online game, an ability to retain an advancement achieved in the enhanced version, and an ability to retain an asset earned in the enhanced version.

11. A system. comprising:
one or more computer processors programmed to perform operations comprising:
providing an online game on a mobile device configured to determine global position information for the mobile device;
determining that an approximate location for the mobile device corresponds to a target geographical region;
sending a request to a user of the mobile device to share the global position information for the mobile device,
wherein the request comprises an invitation to experience an enhanced version of the online game corresponding to the target geographical region;
detecting that the user is sharing the global position information for the mobile device;
confirming, based on the shared global position information, that the mobile device is within the target geographical region; and
providing the enhanced version of the online game on the mobile device.

12. The system of claim 11, wherein the mobile device is configured to determine the global position information using at least one of a global positioning system and a radio signal multilateration system.

13. The system of claim 11, wherein the target geographical region corresponds to at least one of a room, a building, a street, a neighborhood, a park, a town, a city, a business, and any combination thereof.

14. The system of claim 11, wherein determining the approximate location comprises using at least one of a Wi-Fi network and a wireless personal area network.

15. The system of claim 11, wherein the enhanced version of the online game comprises elements tailored for the target geographical region.

16. The system of claim 15, wherein the enhanced version of the online game further comprises a support game.

17. The system of claim 11, further comprising:
determining, based on the shared global position information, that the mobile device has left the target geographical region; and
reverting back to an original version of the online game on the mobile device.

18. The system of claim 11, further comprising:
providing an incentive to the user of the mobile device to continue sharing the global position information for the mobile device.

19. The system of claim 18, wherein providing the incentive comprises providing a notification to the user of the mobile device, wherein the notification is configured to inform the user of an advantage that will be available in the online game if the user continues to share the global position of the mobile device.

20. An article, comprising:
a non-transitory computer-readable medium having instructions stored thereon that, when executed by one or more computer processors, cause the computer processors to perform operations comprising:
providing an online game on a mobile device configured to determine global position information for the mobile device;
determining that an approximate location for the mobile device corresponds to a target geographical region;
sending a request to a user of the mobile device to share the global position information for the mobile device,
wherein the request comprises an invitation to experience an enhanced version of the online game corresponding to the target geographical region;
detecting that the user is sharing the global position information for the mobile device;
confirming, based on the shared global position information, that the mobile device is within the target geographical region; and
providing the enhanced version of the online game on the mobile device.
